(19) United States
(12) Patent Application Publication
(10) Pub. No.: US 2008/0102013 A1
(43) Pub. Date: May 1, 2008

(54) PROVIDING H2O2 FROM SULFURIC ACID, WHICH ARISES DURING THE COMBUSTION OF FOSSIL FUELS AND FROM SULFUR RESIDUES CONTAINED THEREIN, AND USING THE H2O2 AS AN ENERGY CARRIER

(75) Inventor: Florian Krass, Weggis (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SILICON FIRE AG, Meggen (CH)

(21) Appl. No.: 11/776,505

(22) Filed: Jul. 11, 2007

(30) Foreign Application Priority Data
Oct. 29, 2006 (EP) EP06022578.6
Dec. 18, 2006 (EP) EP06126325.7

(51) Int. Cl. C01B 15/03; B60K 6/00; C01B 33/12; C07F 7/04

(52) U.S. Cl. 423/337; 180/165; 423/585; 556/478; 903/902; 903/908

(57) ABSTRACT

The crude oil reserves have a time limit which may be calculated. Before the automobile industry, aviation, the weapons industry, and space travel change their combustion engines over to silanes, for example, hydrogen peroxide will preferably be used as an energy carrier. The hydrogen peroxide may be obtained especially advantageously from a power plant process according to the present invention, in which hydrocarbons contaminated with sulfur are used for combustion. The present invention also relates to a novel system for transporting/conveying hydrogen peroxide.

### CROSS-REFERENCES TO RELATED APPLICATIONS

This application claims the priority of European Patent Application 06 022 578.6, which was filed on Oct. 29, 2006 with the European Patent Office; and

European Patent Application 06 126 325.7, which was filed on Dec. 18, 2006 with the European Patent Office. Both applications are incorporated herein by reference in their entirety for all purposes.

### BACKGROUND OF THE INVENTION

Carbon dioxide is a chemical compound made of carbon and oxygen. Carbon dioxide is a colorless and odorless gas. At low concentration, it is a natural component of air and arises in living organisms during cell respiration, but also during the combustion of carbonaceous substances with sufficient oxygen. Since the beginning of industrialization, the CO₂ component in the atmosphere has significantly increased. The main reasons for this are the CO₂ emissions caused by humans—known as anthropogenic emissions.

The carbon dioxide in the atmosphere absorbs a part of the thermal radiation. This property makes carbon dioxide into a greenhouse gas and is one of the causes of the greenhouse effect.

For these and also other reasons, research and development is currently being performed in greatly varying directions to find a way of reducing the anthropogenic CO₂ emissions. There is a great need for CO₂ reduction in particular in connection with energy production, which is frequently performed by the combustion of fossil energy carriers, such as coal or gas, but also in other combustion processes, for example, during garbage combustion. Hundreds of millions of tons of CO₂ are released into the atmosphere every year by such processes.

The fuels required for producing heat generate CO₂, as explained at the beginning. Up to this point, no one has arrived at the idea of using the sand provided in oil-bearing sands (SiO₂), oil-bearing shale (SiO₂+[CO₃]²), in bauxite, or tar-bearing sands or shales, and other mixtures to reduce the CO₂ discharge and, in addition, obtain new raw materials from the products of such a novel method.

Instead of using naturally occurring mixtures of sand and oil in this novel method, industrial or natural waste containing hydrocarbons, possibly after admixing with sand, may also be used. Using natural asphalt (also referred to as mineral pitch) instead of the oil component is also conceivable. A mixture made of asphalt with pure sand or with construction rubble which contains a sand component is especially preferable.

However, water glass, a mixture of sand with acid or base, may also be used, the water glass being admixed with mineral oils in order to provide the hydrocarbon component necessary for the present invention (microemulsion method).

The reserves of oil-bearing sands (SiO₂) and shales (SiO₂+[CO₃]²) are known to exceed the world oil reserves multiple times over. The technical methods applied for separating oil and minerals are currently ineffective and too costly. Natural asphalt occurs at multiple locations of the earth, but is currently mined at commercial scale primarily in Trinidad.

Sand occurs in greater or lesser concentrations everywhere on the surface of the earth. A majority of the sand occurring comprises quartz (silicon dioxide; SiO₂).

A further problem of current power plant processes which are based on the combustion of hydrocarbons is the resulting sulfuric acid, which arises from sulfur impurities of the hydrocarbons. There are methods for handling the sulfuric acid in the flue gases, but these desulfurization processes are complex and expensive. Furthermore, hydrogen and fuel cells are currently increasingly being used. However, as is well-known, the handling of hydrogen is not without problems and the transport has not yet been satisfactorily solved.

The object of the present invention is to provide such possible raw materials and describe their technical production. The chemical findings used in the method are characterized in that the hydrocarbons present in the sand and shales and other mixtures participate in a reaction, and also the SiO₂ is chemically changed by the reaction.

In addition, it is an object to provide alternative solution approaches for generating energy and safely transporting energy.

Inter alia, the present invention uses the fact that silicon (e.g., as a powder at suitable temperature) may be reacted after ignition directly with pure (cold) nitrogen (e.g., nitrogen from the ambient air) to form silicon nitride, because the reaction is strongly exothermic. (Si₃N₄ is a solid noble gas [Plichta].) The heat thus arising may be used in reactors.

The silicon resulting from oil sand, oil shale, or bauxite, depending on the method, in power plant processes has surfactant properties and may be treated catalytically (e.g., using magnesium and/or aluminum as a catalyst) with hydrogen, monosilane resulting. This monosilane may be removed from the reaction chamber and subjected at another location a further time to a catalytic pressure reaction. According to the equation

Si+SiH₄→(Using catalysts such as Pt, etc.)→Si(SiH₄₄)+SiHₙ(SiH₄)ₘ+SiₙHₘ

long-chain silanes may be prepared, which may be used both in the technology of fuel cells and in engines.

The silicon, but also the silanes, are outstanding energy suppliers which may be conveyed without problems to a consumer. However, hydrogen peroxide is better suitable as a energy supplier. The hydrogen peroxide may be generated in a process which may be coupled to a fossil power plant process or integrated in such a process. This is also true for the production of silicon or silanes, which may also be integrated in such a process or coupled to such a process.

Further details and advantages of the present invention are described in the following on the basis of exemplary embodiments.

### BRIEF SUMMARY OF THE INVENTION

Providing H₂O₂ from sulfuric acid, which arises during the combustion of fossil fuels from sulfur residues contained therein, and using the H₂O₂ as an energy carrier.

### DETAILED DESCRIPTION OF THE INVENTION

In the following, the present invention is described on the basis of examples. A first example relates to the application of the present invention in a power plant operation, in order to reduce or even eliminate the CO₂ discharge arising therein while obtaining energy.

According to the present invention, there is an array of chemical reactions running in a targeted way, in which new chemical compounds (called products) result from the starting materials (also called educts or reactants). The reactions according to the present invention of the method identified at the beginning as the main process are designed in such a way that CO₂ is consumed and/or bound in significant quantities.

In a first exemplary embodiment, sand which is admixed with mineral oil or oil shales are used as starting materials, for example. These starting materials are supplied to a reaction chamber, for example, in the form of an afterburner or a combustion chamber. CO₂ is blown into this chamber. In the first exemplary embodiment, this CO₂ may be the CO₂ exhaust gas which arises in large quantities when obtaining energy from fossil combustibles and up to now has escaped into the atmosphere in many cases. In addition, (ambient) air is supplied to the chamber. Instead of the ambient air, or in addition to the ambient air, steam or hypercritical H₂O at over 407° C. may be supplied to the method.

Furthermore, nitrogen is to be blown in at another point in the method, or the combustion chamber, respectively.

In addition, a type of catalyst is used. Aluminum is especially suitable. Under suitable environmental conditions, a reduction occurs in the chamber, which may be represented greatly simplified as follows:

SiO2→Si

This means that the quartz component present in the sand or shale is converted into crystalline silicon.

The mineral oil of the sand used assumes the role of the primary energy supplier and is largely decomposed pyrolytically into hydrogen (H₂) and a compound similar to graphite at temperatures above 1000° C. in the method according to the present invention. The hydrogen is thus withdrawn from the hydrocarbon chain of the mineral oil in the running reactions. The hydrogen may be diverted into pipeline systems of the natural gas industry or stored in hydrogen tanks, for example.

In a second exemplary embodiment, the present invention is applied in connection with a pyrolysis method of Pyromex AG, Switzerland.

The present invention may also be used as a supplement or alternative to the oxyfuel method. Thus, for example, using the present invention, heat may be obtained by an energy cascade according to the following approach. In an alteration of the oxyfuel method, additional heat is generated with the addition of aluminum, preferably liquid aluminum, and with combustion of oil sand (instead of oil or coal) with oxygen (O₂) and, if needed, also nitrogen (N₂) (Wacker accident). If the nitrogen coupling to silicon compounds is needed, the pure nitrogen atmosphere is preferably achieved from ambient air by combustion of the oxygen component of the air with propane gas (known from propane nitration).

According to the present invention, aluminum (Al) may be used. It is currently only possible to obtain aluminum cost-effectively from bauxite. Bauxite contains approximately 60% aluminum oxide (Al₂O₃), approximately 30% iron oxide (Fe₂O₃), silicon oxide (SiO₂), and water. This means the bauxite is typically always contaminated with the iron oxide (Fe₂O₃) and the silicon oxide (SiO₂).

Al₂O₃ may not be chemically reduced because of its extremely high lattice energy. However, it is possible to produce aluminum industrially by fused-salt electrolysis (cryolite-alumina method) of aluminum oxide Al₂O₃. The Al₂O₃ is obtained by the Bayer method, for example. In the cryolite-alumina method, the aluminum oxide is melted with cryolite (salt: Na₃[AlF₆]) and electrolyzed. In order not to have to work at the high melting temperatures of aluminum oxide of 2000° C., the aluminum oxide is dissolved in a melt of cryolite. Therefore, the operating temperature in the method is only from 940 to 980° C.

In fused-salt electrolysis, liquid aluminum arises at the cathode and oxygen arises at the anode. Carbon blocks (graphite) are used as anodes. These anodes burn off due to the resulting oxygen and must be continuously renewed.

It is seen as a significant disadvantage of the cryolite-alumina method that it is very energy consuming because of the high binding energy of the aluminum. The formation and emission of fluorine, which sometimes occurs, is problematic for the environment.

In the method according to the present invention, bauxite may be added to the method to achieve cooling of the process. The excess thermal energy in the system may be handled by the bauxite. This is performed analogously to the method in which scrap iron is supplied to an iron melt in a blast furnace for cooling when the iron melt becomes too hot.

Cryolite may be used as an aid if the method threatens to go out of control (see Wacker accident), in order to thus reduce the temperature in the system in the meaning of emergency cooling.

Like silicon carbide, silicon nitride is a wear resistant material which can be or is used in highly stressed parts in mechanical engineering, turbine construction, chemical apparatus, and engine construction.

Further details on the chemical proceedings and energy processes described may be inferred from the following pages

Quartz sand may be reacted with liquid aluminum exothermically to form silicon and aluminum oxide according to the Holleman-Wiberg textbook:

3 SiO₂+4 Al(1)→Si+2 Al₂O₃ ΔH=−618.8 kJ/Mol (exothermic)

Silicon combusts with nitrogen to form silicon nitride at 1350° C. The reaction is again exothermic

T=1350° C.

3 Si+2 N₂ (g)→Si₃N₄ΔH=−744 kJ/Mol (exothermic)

Silicon reacts slightly exothermically with carbon to form silicon carbide.

Si+C→SiC ΔH=−65.3 kJ/Mol (exothermic)

In addition, silicon carbide may be obtained endothermically directly from sand and carbon at approximately 2000° C.:

T=2000° C.

SiO₂+3 C (g)→SiC+2 CO ΔH =+625,3 kJ/Mol (endothermic)

In order to reclaim aluminum from the byproduct bauxite or aluminum oxide Al₂O₃, liquid Al₂O₃ (melting point 2045° C.) is electrolyzed without adding cryolite to form aluminum and oxygen. The reaction is strongly endothermic and is used for cooling the exothermic reactions.

2 Al₂O₃ (I)→4 Al (I)+3 O₂ (g) ΔH=+1676,8 kJ/Mol (endothermic)

Production of the Silanes:

Magnesium reacts with silicon to form magnesium silicide:

2 Mg+Si→Mg₂Si

Magnesium silicide reacts with hydrochloric acid to form monosilane SiH₄ and magnesium chloride:

Mg₂Si+4 HCl (g)→SiH₄+2 MgCl₂

This synthetic pathway must actually also function with aluminum: as a result, aluminum silicide Al₄Si₃ arises as an intermediate product.

Higher silanes are possibly only accessible via polymerization of SiCl₂ with SiCl₄ and by subsequent reaction with LiAlH₄, as the preceding work documents.

In the following, further essential aspects of the present invention are described.

As described at the beginning, the fossil fuels which are combusted in energy plants are loaded with sulfur residues. According to the present invention, H₂O₂ may be provided as an energy carrier in a power plant process based on fossil fuels. Sulfur compounds from the power plant process are combined with water and/or water steam to thus produce sulfuric acid (H₂SO₄). The sulfuric acid is converted into peroxosulfuric acid by supplying current at an electrode (anode). The peroxosulfuric acid is decomposed into sulfuric acid and H₂O₂ by a hydrolysis process. The peroxosulfuric acid hydrolyzes relatively rapidly in water to form H2O2 and sulfuric acid, as shown in simplified form in the following reaction:

H₂SO₅+H₂O→H₂SO₄+H₂O₂

In the present application and in the claims, the term peroxosulfuric acid is used for H₂SO₅, for H₂S₂O₈ (also known as peroxodisulfuric acid), and also for a mixture of H₂SO₅ and H₂S₂O₈.

According to the present invention, the sulfuric acid is then separated off to provide a solution made of H₂O₂ with water.

Since pure (=water-free) H₂O₂ is unstable and may explode spontaneously, when it comes into contact with metals, for example, it is circulated according to the present invention in at most seventy-percent solution in water (in aqueous solution). This limiting value of 70% is referred to here as the critical concentration limit.

The solution is selected according to the present invention so that the concentration of H₂O₂ lies below the critical concentration limit. The solution is then transported to a consumer (filling station, final consumer). By cleaving off hydrogen and/or oxygen from the solution, energy may be generated at the consumer by using the hydrogen and/or oxygen as an energy supplier and/or fuel.

Oxygen is preferably used in the reaction to peroxosulfuric acid, which is taken either from the (ambient) air, from CO₂ exhaust gas of the power plant process, or from a silicon dioxide reduction process, as described above.

The H₂O₂ is especially well suitable as an energy supplier or fuel. The H₂O₂ may be conveyed without problems as a solution to a consumer through a pipeline system, in particular a water line system already in existence. This is absolutely nonhazardous, since it is provided in a concentration below 70%. Conducting the solution through the pipeline system sterilizes it, which may be important especially in hot areas and in areas having water which is otherwise not disinfected. Use is thus made of the fact that the H₂O₂ has a disinfectant action.

According to the present invention, drinking water and, in addition, H₂O₂ as an energy supplier may be transported jointly over long distances through a pipeline system already in existence. Pipes which have a thin coating (e.g., of plastic) inside are especially suitable, in order to be able to conduct the slightly acid solution better. A thin Teflon or nylon coating is especially suitable. Plastic pipes may also be used.

The solution may also be transported to a consumer by a transport vehicle, this transport preferably being performed unpressurized or at low pressure, however.

The H₂O₂ solution may also be provided for further use at a filling station.

At the location of use, the H₂O₂ from the solution may be caused to react with silicon (for example, in a reactor or furnace), in order to thus generate SiO₂ and water, this reaction releasing energy.

However, hydrogen and/or oxygen may also be catalytically cleaved from the solution at the location of use.

An approach in which the pipeline system is designed as self-healing is especially preferable. With a suitable design, hairline cracks, defects, or by breaks of the pipeline system may result in an enrichment of the solution in the wall of the pipeline system or outside thereof. The solution may be used for automatic sealing, healing, or repair there by a polymerization process (for example, using polyurethane or by a propylene oxide method based on hydrogen peroxide). Thus, for example, aging pipes may still be used. In addition, because of the disinfectant action, local nests of contaminants and bacteria are killed.

In a further embodiment, a small proportion of the H₂O₂ from the H₂O₂ solution is supplied to the wastewater system to at least partially treat the wastewater. The disinfectant action may also be used here. In addition, the H₂O₂ encourages the decomposition of natural wastes and other substances.

The H₂O₂ may also be mixed at the consumer with substances containing carbohydrates, such as biological substances like sugar, to increase the caloric value. However, excrement may also be admixed with H₂O₂, in order to then supply it to a combustion process. Energy may also be obtained in this way.

At the consumer, the H₂O₂ may be provided at a concentration less than 15%, in order to be used there as a disinfectant and/or cleaning and/or washing and/or flushing agent, for example. By addition to a washing or dishwashing machine, the detergent used until now may be reduced or left out entirely.

At the consumer, the H₂O₂ may also be provided at an increased concentration, which is performed by withdrawing the water from the solution.

According to the present invention, novel remote energy delivery systems may be provided, which at least partially replace power lines. Such a remote energy delivery system comprises pipeline systems which deliver an aqueous solution of H₂O₂ from an energy supplier (such as a power plant) to a consumer, the concentration of H₂O₂ in the solution being below the critical concentration value.

Coupling this remote energy delivery system to a power plant operation, in which a power plant process based on fossil fuels runs and in which the H₂O₂ is obtained from the sulfur, is especially advantageous. The remote energy delivery system may also be coupled to a power plant operation in which a power plant process based on a silicon dioxide compound containing hydrocarbons runs.

The remote energy delivery system preferably comprises a reactor or furnace, which is situated at the location of use and causes H₂O₂ from the solution to react with silicon, in order to thus generate SiO₂ and water, this reaction releasing large quantities of energy.

The remote energy delivery system may also comprise a catalyst, which is situated at the location of use and catalytically executes the cleavage of hydrogen and/or oxygen from the solution.

The remote energy delivery system may also be designed in such a way that if hairline cracks, defects, or pipe breaks of the pipeline system occur, there is an enrichment of the solution in the wall or outside thereof, the solution there resulting in an automatic sealing, healing, or repair by a polymerization process (for example using polyurethane).

The present invention may also be used in a power plant process, in which a silicon dioxide compound containing hydrocarbons (e.g., oil sand, oil shale, bauxite contaminated with silicon oxide) are introduced into a combustion zone. The silicon dioxide from the silicon dioxide compound containing hydrocarbons is then converted into silicon (Si₂) and/or silanes using liquid or powdered aluminum, or using halogen compounds. The silicon and/or the silanes are then transported to a consumer. The silicon and/or the silanes are used there as an energy supplier by oxidation with oxygen and/or by nitration with nitrogen and/or carbonation with carbon. In this case, instead of the hydrogen peroxide, silicon or silanes are thus used as the energy suppliers.

Vehicles having a novel hybrid drive may also be implemented according to the present invention. In this type of drive, hydrogen from a silane oil (higher-chain silicon-hydrogen compound) is used in a fuel cell which powers the vehicle. The current generated by the fuel-cell may drive an electric motor. Simultaneously or alternatively thereto, waste heat from a reaction of silicon with oxygen from the H₂O₂ is used in a reactor cell as a further energy supplier of the vehicle. This H₂O₂ may be received together with the silane oil at a filling station, for example. For this purpose, the vehicle preferably has two separate tanks.

The large-scale production methods for H₂O₂ up to this point are very energy consuming and costly. The novel approach presented herein may be used as a basis for a significantly more cost-effective method for producing H₂O₂.

What is claimed is:

1. A method for providing H2O2 as an energy supplier in a power plant process based on fossil combustibles, having the following steps:
combining sulfur compounds from the energy plant process with water and/or water steam, in order to thus generate sulfuric acid,
converting sulfuric acid into peroxosulfuric acid by supplying current to an electrode,
decomposing the peroxosulfuric acid into sulfuric acid and H2O2 by hydrolysis,
separating off the sulfuric acid and providing a solution of H2O2 with water, so that the concentration of H2O2 lies below the critical concentration limit,
transporting this solution to a consumer,
separating hydrogen and/or oxygen from the solution at the consumer,
using the hydrogen and/or oxygen as an energy supplier and/or fuel.

2. The method according to claim 1, characterized in that oxygen, which arises either from the air, from CO2 waste gas of the power plant process, or from a silicon dioxide reduction process, is used in the conversion to peroxosulfuric acid.

3. The method according to claim 1, characterized in that said solution is transported to a consumer through a pipeline system, in particular an already existing water line system.

4. The method according to claim 1, characterized in that said solution is transported to a consumer by a transport vehicle, this transport preferably being performed non-pressurized or at low pressure.

5. The method according to claim 3, characterized in that said solution is provided at a filling station for further use.

6. The method according to claim 1, characterized in that H₂O₂ from the solution is caused to react with silicon at the location of use, in order to thus generate SiO₂ and water, this reaction releasing energy.

7. The method according to claim 1, characterized in that the hydrogen and/or oxygen is separated from the solution catalytically.

8. The method according to claim 3, characterized in that as said solution is conducted through the pipeline system, the system is disinfected.

9. The method according to claim 3, characterized in that hairline cracks, defects, or pipe breaks of the pipeline system result in an enrichment of said solution in the wall of the pipeline system or outside thereof, said solution resulting in automatic sealing, healing, or repair there by a polymerization process (for example, using polyurethane).

10. The method according to claim 3, characterized in that drinking water and, in addition, H₂O₂ as an energy supplier are transportable over long distances by the pipeline system.

11. The method according to claim 3, characterized in that at least a small proportion of the H₂O₂ from the H₂O₂ solution is supplied to the wastewater system, in order to at least partially treat the wastewater.

12. The method according to claim 3, characterized in that H₂O₂ is admixed at the consumer with substances containing carbohydrates, such as biological substances like sugar.

13. The method according to claim 3, characterized in that H₂O₂ is provided at a concentration less than 15% at the consumer, in order to be used there as a disinfectant and/or cleaning and/or washing and/or flushing agent, for example.

14. The method according to claim 3, characterized in that H₂O₂ is provided at an increased concentration at the consumer, which is performed by removing the water from the solution.

15. The method according to claim 1, characterized by the following steps:
introducing a silicon dioxide compound containing hydrocarbons (such as oil sand) into a combustion zone,
converting silicon dioxide from the silicon dioxide compound containing hydrocarbons into silicon (Si₂) and/or silanes using liquid or powdered aluminum, or using halogen compounds,
transporting the silicon and/or the silanes to a consumer,
using the silicon and/or the silanes as an energy supplier by oxidation with oxygen and/or by nitration with nitrogen and/or carbonization with carbon or CO₂ and/or sulfide formation with sulfur.

16. A remote energy delivery system having pipeline systems, which deliver an aqueous solution of H₂O₂ from an energy supplier to a consumer, the concentration of H₂O₂ in the solution being below the critical concentration limit.

17. The remote energy delivery system according to claim 16, characterized in that it is coupled to
a power plant operation, in which a power plant process based on fossil combustibles runs, or
a power plant operation, in which a power plant process based on a silicon dioxide compound containing hydrocarbons runs.

18. The remote energy delivery system according to claim 16, characterized in that it comprises a reactor or furnace, which is situated at the location of use and causes H₂O₂ from said solution to react with silicon, in order to thus generate SiO₂ and water, this reaction releasing energy.

19. The remote energy delivery system according to claim 16, characterized in that it comprises a catalyst, which is situated at the location of use, and hydrogen and/or oxygen are cleaved catalytically from the solution.

20. The remote energy delivery system according to claim 16, characterized in that the walls of the pipeline system are designed in such a way that in the event of hairline cracks, defects, or pipe breaks of the pipeline system, an enrichment of the solution occurs in the wall or outside thereof, the solution resulting there in automatic sealing, healing, or repair by a polymerization process (for example, using polyurethane).

21. A method for driving a vehicle, characterized in that
hydrogen from a silane oil (higher-chain silicon-hydrogen compound) powers a fuel cell of the vehicle and the energy thus generated drives an electric motor, and
waste heat from a reaction of silicon with oxygen from H₂O₂ in a reactor cell is used as a further energy supplier of the vehicle.

22. A vehicle having a hybrid drive which is based on a method according to claim 21.
